(19) United States
(12) Patent Application Publication
(10) Pub. No.: US 2022/0076200 A1
(43) Pub. Date: Mar. 10, 2022

(54) MOBILE FOOD PRODUCTION MANAGEMENT SYSTEM

(71) Applicant: TECHNOLOGY LICENSING CORPORATION, FORT LAUDERDALE, FL (US)

(72) Inventors: BEN KOETHER, FORT LAUDERDALE, FL (US); EDWARD MUSIAL, MONROE, CT (US); MIKE KEEFE, BROOKFIELD, CT (US)

(21) Appl. No.: 17/466,652

(22) Filed: Sep. 3, 2021

Related U.S. Application Data
(60) Provisional application No. 63/075,522, filed on Sep. 8, 2020.

(51) Int. Cl. G06Q 10/08; G06Q 10/04; G06Q 50/12

(52) U.S. Cl. CPC G06Q 10/0832; G06Q 50/12; G06Q 10/047; G06Q 10/0833

(57) ABSTRACT

A system for controlling cooking as a function of physical location of the control panel includes a control panel having a position determination unit, such as an accelerometer. The control panel includes a microprocessor and communication device. A library of control instructions, stores the recipes, including a time necessary to prepare the food, and an operation time of the cooking appliance. An application for determining a desired route between two locations is in communication with the control panel as well. The control panel communicates with the library and application utilizing the communication device.

### CROSS REFERENCE TO RELATED APPLICATION

This application claims the benefit of U.S. Provisional Application No. 63/075,522 filed on Sep. 8, 2020, the entire disclosure of which is hereby incorporated in its entirety.

### BACKGROUND OF THE INVENTION

The present invention relates to a control system for a cooking appliance, and more particularly, a control system for changing the operation of the cooking appliance to account for a distance between the cooking appliance and the geographical location at which the food cooked by the cooking appliance is to be consumed.

Commercially prepared food has always been mobile. At first, the restaurants themselves would offer local delivery of foods prepared at the restaurant; the most common being the pizza delivery driver. This practice expanded to an independent network of delivery vehicles such as Uber Eats®, by way of example, in which third parties pick up finished food products to be delivered to one or more residential or office locations. At the same time, commercially prepared food became mobile with the advent of food trucks where the kitchen itself moved to a more convenient customer location to maximize accessibility.

The popularity of food delivered to the home and office has created a de facto contest as to which restaurant can provide food fastest and freshest to a customer location. One prominent pizza delivery chain, has even advertised fixing potholes to ensure that its delivery staff can provide prompt delivery of fresh hot pizza and intact. A food company providing pizza to be baked at home advertises that even the winner of the delivery contest cannot deliver food as fresh, warm and intact as cooking at home. Furthermore delays in delivery may bring food quality and safety into question.

Kitchen appliances, particularly in the commercial environment, are operated under the control of sophisticated control hardware and software. The hardware and software is contained at least in part in a control panel for the individual kitchen appliance to which it is attached. The most common example is the touch control for a microwave oven, but control panels are also provided to operate sophisticated fryers and ovens in commercial settings. The touch of a button can automatically control the placing of a fry article in the vat, and removal thereof a predetermined time later. In an oven they control cooking time, cook temperature, and even timing and direction of convection currents. While the controls are sophisticated they do not take into account the location at which the food is to be consumed when executing a recipe.

Accordingly, there is a need for a control system for a cooking appliance that can account for changes in location of the control panel and associated cooking device to change the recipe under which the cooking appliance operates to ensure conformity, quality and freshness of finished product at the delivery destination as a function of the distance and/or time travelled by the cooking appliance.

### SUMMARY OF THE INVENTION

The system for controlling cooking as a function of physical location of the control panel includes a control panel having a position determination unit, such as an accelerometer. The control panel includes a microprocessor and communication device. A library of control instructions, stores the recipes including ingredients, preparation steps, and a time necessary to prepare the food, including an operation time of the cooking appliance. An application for determining a desired route between two locations is in communication with the control panel as well. The control panel communicates with the library and application utilizing the communication device.

During operation, the cooking appliance determines a current location. Food is ordered to be prepared and a recipe for preparation of the ordered food is retrieved from the library along with information regarding the time necessary to prepare the recipe. A route is determined between the location of the cooking appliance and a location where the food is to be delivered. The microprocessor at the cooking appliance compares the time necessary to operate the cooking appliance in accordance with the recipe and the time required to traverse the route.

If the time necessary to traverse the route is greater than the time necessary to operate the cooking appliance in accordance with the recipe, then a delay is input to the control panel to delay the operation of the cooking appliance sufficiently to equalize the time necessary for the cooking appliance to operate in accordance with the recipe and the time necessary to complete the route. If the time to complete the route is less than the time necessary to complete the recipe, then either the start time for traversing the route is delayed, or a second route requiring a longer time to traverse the route is selected.

### BRIEF DESCRIPTION OF THE DRAWINGS

The features and advantages of the present invention will become more readily apparent from the following detailed description of the invention in which like elements are labeled similarly and in which:

FIG. 1 is a schematic view of a food truck having a cooking appliance constructed in accordance with the invention;

FIG. 2 is a schematic drawing of the system for controlling a cooking appliance in accordance with the invention; and

FIG. 3 is a flowchart for the operation of the system for controlling a cooking appliance in accordance with the invention.

### DETAILED DESCRIPTION OF THE PREFERRED EMBODIMENTS

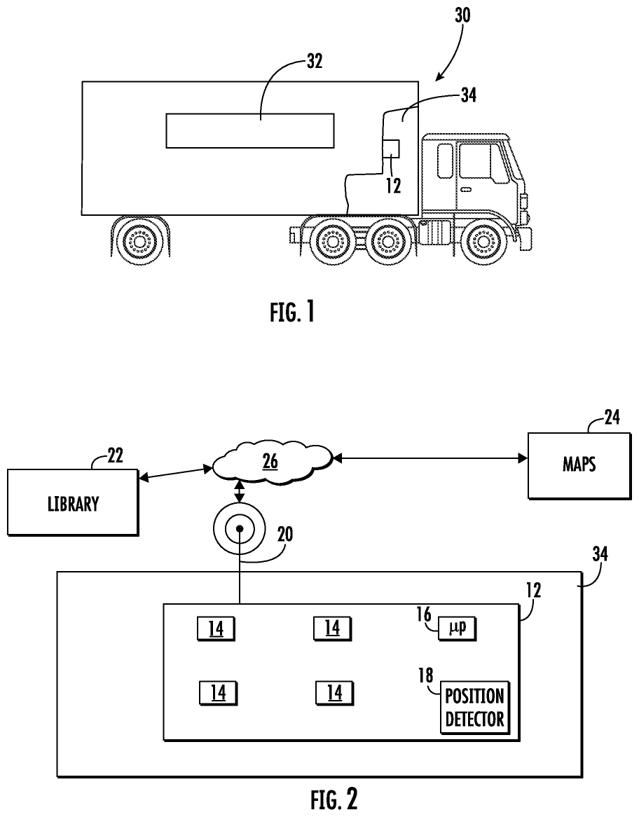

Reference is initially made to FIG. 1 in which a schematic diagram of a food truck 30 is provided. For the purposes of this application, a food truck is defined as a motorized vehicle having at least one cooking appliance thereon for preparing and cooking food on the vehicle. As known in the art, food truck 30 may have a window 32 within the body of truck 34 providing access between a chef within food truck 30 and customers. At least one cooking appliance 34 is provided within food truck 30 for the preparation of food. Food truck 30 may also include a staging area (not shown) as known in the art for preparation of food prior to placement in cooking appliance 34. Cooking appliance 34 is provided with a control panel 12, communicating with a microprocessor 16 (FIG. 2), for controlling operation of the cooking appliance 34.

Reference is now made to FIG. 2 in which a schematic diagram for a system 10 for controlling a cooking appliance 34 to account for change in location of the cooking appliance 34 during the cooking operation in accordance with the invention is provided. System 10 includes a control panel 12 operatively coupled to cooking appliance 34 having a number of control inputs 14 which, as known in the art, may be physical or virtual buttons; each button corresponding to different control parameters for controlling cooking appliance 34. For the purposes of this description one or more control parameters for operating cooking appliance 34 to prepare a specific food item is called a recipe. One button 14 is reserved for entering a delivery address for the selected food.

In this embodiment, for ease of illustration, the cooking appliance 34 is an oven for cooking bread based products, such as pizza, garlic rolls, bread sticks and the like. Therefore one control button 14 may correspond to the recipe, control parameters, for cooking a deep dish pizza, while a second button 14 may correspond to cooking a Neapolitan pizza, and a third button 14 may correspond to garlic rolls, including controlling different portions of oven 34; all of which correspond to a different set of control parameters; recipe.

Control panel 12 is operatively coupled to microprocessor 16. Microprocessor 16 operates on the control parameters, recipe, associated with each respective button 14 to operate cooking appliance 34 to perform the recipe. Cooking appliance 34 is provided with a position detector 18, disposed near control panel 12, and preferably forming a portion of control panel 12 and/or cooking appliance 34. Position detector 18 may be a GPS device as known in the art, or as described below in greater detail, an onboard accelerometer. Position detector 18 communicates with microprocessor 16. Microprocessor 16 stores a current geographical location of the control panel 12, and in turn cooking appliance 34 to which it is associated.

Control panel 12 is operatively coupled with a communication device 20 such as, in this embodiment, a wireless communication device illustrated by an antenna. Communication device 20 may enable wireless communication such as cellular communication utilizing a cellular phone 28, Wi-Fi communication, radio transmission, and may make use of a cloud 26 to communicate with remote devices such as a library 22. Library 22 may be a local library stored at cooking appliance 34, food truck 30, or, in a preferred embodiment, is a remote central library which may communicate with two or more control panels 12 and/or microprocessors 16.

In one preferred embodiment position detector 18 is a GPS device which is periodically polled by microprocessor 16 to determine current location. In an alternative embodiment position detector 18 may be an accelerometer operatively coupled to microprocessor 16. Accelerometer 18 monitors movement and indicates travel direction and travel distance of items with which they are associated. Therefore, accelerometer 18 is utilized to determine movement of control panel 12 relative to a known location, and output an acceleration signal when movement is detected to microprocessor 16. In this way position detector 18 also broadcasts direction changes to microprocessor 16, rather than, or in addition to, being periodically polled.

Control panel 12 is described as a control panel for an oven baking dough-based products by way of non limiting example; however the associated cooking appliance 34 under the control of the control panel 14 may be a fryer, a proofer or the like. The oven may also be other types of ovens, for example the cooking appliance 34 may correspond to an oven to cook roast beef, while another oven may be an oven for baking chicken, and a different cooking appliance could be for frying french fries, fish or chicken.

The recipes within these types of control panels may also vary as a function of size of the oven (load), and the chicken part being baked (breasts vs. wings). Therefore use of the same control parameters for different types of food by control panel 12 could result in misoperation of the oven, and the health violations resulting therefrom. Furthermore, operation of the cooking appliance 34 in the same manner across various recipes could result in arriving too early or too late at a desired destination with ready to serve food not at its peak “out of the oven” freshness.

In the preferred nonlimiting embodiment, microprocessor 16, position detector 18 and communications device 20 are located on control panel 12 for simplified repair and interchangeability with other cooking appliances 34. However, it is well within the scope of the invention to provide all, or some of these constituent parts on cooking appliance 34. Additionally, library 22 in a preferred nonlimiting embodiment, is illustrated as a remote library in communication with control panel 12 so that a single library 22 can be available to several cooking appliances 34 constructed in accordance with the invention. However, library 22 may also be stored locally at cooking appliance 34 or food truck 30 and updated from time to time as needed.

System 10 includes library 22 which stores recipes associated with preparation times, particularly cooking times. Each recipe stored in library 22, as known in the art includes a preparation time, and a time period during which the food is processed by cooking appliance 34. As a result, one performing the recipe is provided with a time necessary to prepare the food, the time necessary to cook the food with cooking appliance 34, and a total time to complete the recipe. Microprocessor 12 communicates with library 22 utilizing communication device 20.

Microprocessor 16 also communicates with a driving route library, or application, system 24 such as that provided by Google® maps or MapQuest® (collectively and respectively each a map source) by way of non limiting example. Microprocessor 16 communicates with these map sources 24 utilizing communication device 20 to determine travel routes and the estimated time required to traverse the route from a current location determined by position detector 18 and a next location, known to microprocessor 16, where the food is to be delivered.

Utilizing food truck 30 and system 10, it is possible to prepare food using programmable operating structure on a mobile platform in a way to optimize the condition of the food as it is delivered to an end-user; corresponding the recipe cook time to a delivery time. This ensures a the food arriving at the destination in a freshest state; “just out of the oven”.

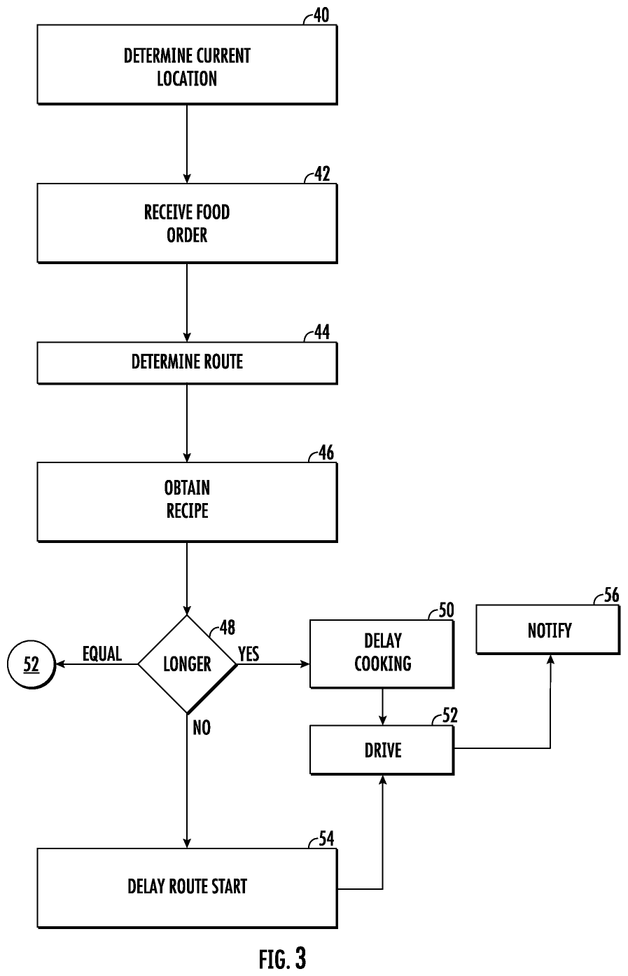

Reference is now made to FIG. 3 in which a flowchart depicting the operation of system 10 in accordance with the invention is provided. In a step 40, microprocessor 14, on board truck 30, is continuously monitoring position detector 18 to determine whether an acceleration signal has been output requiring an update of the current location, or the GPS device has indicated any change from a previously reported current location. When food is ordered for delivery, in a step 42 the food type and delivery location are input at control panel 12.

In a step 44, microprocessor 16 communicates with map source 24 utilizing communication device 20 and provides map source 24 the current location and the delivery or destination location. As known in the art, map source 24 determines a route between locations with a predicted time to complete the route. This information is transmitted to control panel 12 and microprocessor 16 at control panel 12.

Simultaneously therewith, on a separate track, before route determination, or after route determination, in a step 46, microprocessor 16 transmits the food identified in the food order to library 22. Library 22 transmits the recipe corresponding to the identified food to microprocessor 16. The recipe includes preparation time and the time period during which cooking appliance 34 is operated. At this time, with recipe in hand, an operator can begin the manual food prep required prior to cooking.

As discussed above, control panel 12 is a sophisticated control, capable of automatically operating cooking appliance 34, including start times, stop times, and even changing temperatures, convection directions, and convection speeds in accordance with the recipe. To maximize the “out of the oven” freshness of the food product when delivered, the cooking appliance 34 is operated in route. Therefore, the system 10, to optimize the food product quality and timeliness, synchronizes cooking time with arrival time of food truck 30 at the delivery location.

In a step 48, microprocessor 16 compares the operation time of cooking appliance 34 required in the recipe with the anticipated travel time of the delivery route. If the time of operation for cooking appliance 34 substantially equals the time to traverse the projected route, then in a step 52, a button 14 corresponding to the immediate start of cooking appliance 34 is selected and driving of the route begins.

If it is determined that the time required to traverse the route is longer than the time required to operate cooking appliance 34 in step 48, then in a step 50 an input button 14 corresponding to a delay of the of the time required to equalize the route time to the recipe time is selected. The food truck is then driven in a step 52 and along the route microprocessor 16 causes cooking appliance 34 to operate after the delay. Lastly, if it is determined in step 48 that the time required in the recipe to operate cooking appliance 34 in accordance with the recipe is longer, (i.e. time required to traverse the route is not longer than the time required to operate cooking appliance 34) than the time required to traverse the route, then the time differential is indicated to the food operator by microprocessor 16. The food operator may then delay the start of the delivery route for a necessary time period to equalize the cooking time with the route travel time in step 54 before driving in step 52, or cause microprocessor 16 to select a longer route.

To determine a route travel time for steps 50, 54 microprocessor 16 calculates the location of delivery relative to a start location. The same structure can also calculate the current position of the vehicle 30 relative to the destination during drive step 52 by periodically, or continuously, calculating a current location and comparing it to the destination location. Microprocessor 16 calculates a time to arrival at the destination being less than a predetermined amount and utilizes autodial technology for cellular phone 28 known in the art to notify the customer of the arrival time of the vehicle 30, and the food contained therein, in a step 56. In this way, the customer can time their arrival at a delivery location as vehicle 30 arrives and the food is taken out of cooking appliance 34.

Upon arrival the food is removed from cooking appliance 34, and delivered to the destination in the same manner and state of freshness as if cooked at home or delivered at a restaurant table. As a result, the freshest professionally prepared product is now available at the office or home, of a higher quality, and greater likelihood of food safety compliance when compared to conventional delivery and travel of prepared meals.

With respect to the foregoing embodiments of the invention which have been described, it should be recognized that communications, whether between the appliance, libraries, or respective microprocessors, or any combination thereof, may be accomplished by any suitable wireless or wired means (when distributed between cooking appliance and control panel, or stored on board) for the intended application and is a matter of design choice. Preferably, communications are effectuated through wireless communication platforms whose technology is well-established and known to those skilled in the art. More preferably, the wireless communications are performed over the cloud, using established nationwide wireless networks.

It should further be recognized that the invention is not limited to the particular embodiments described above. Accordingly, numerous modifications can be made without departing from the spirit of the invention and scope of the claims appended hereto. Moreover, the invention is not limited to use with any particular type of food product or appliance, and will find broad applicability in the food preparation service industry wherever the invention may be feasibly employed. Thus, the invention may be used with ovens, fryers, proofer's and the like which may be provided with microprocessor-based controller's to provide communication interface within the system in network of the invention. Accordingly, these appliances may be cloud enabled to effectuate communications with the system via the Internet.

What is claimed is:

1. A mobile food production management system comprising:
a control panel for controlling the operation of a cooking appliance disposed on a mobile cooking appliance;
a microprocessor operatively coupled to and in communication with the control panel;
a position detector in communication with the microprocessor; the position detector determining a location and outputting a location signal to the microprocessor corresponding to a current location of the cooking appliance;
a library, in communication with the microprocessor, the library storing recipes, each recipe including a time of operation of the cooking appliance to prepare the food in accordance with the recipe; the library communicating a recipe to the microprocessor in response to a request from the microprocessor;
a map source in communication with the microprocessor, the map source determining a route and a route traverse time as a function of a current location and a delivery location; and
the microprocessor receiving an order for food as input at the control panel; the microprocessor receiving a destination location as input at the control panel, and receives a recipe from the library for the food; the microprocessor transmits the current location and the delivery location to the map source, and receives a route and route traverse time in response thereto, and compares a time for operating the cooking appliance in accordance with the recipe to the route traverse time to create a comparison, and operates the cooking appliance as a function of the comparison.

2. The mobile food production management system of claim 1, wherein the microprocessor determines a delay time to begin operation of the coking appliance, in accordance with the recipe, along the route of the cooking appliance, when the microprocessor determines the route traverse time is greater than a time for operating the cooking appliance during performance of the recipe;

3. The mobile food production management system of claim 1, wherein the microprocessor determines a delay time to begin travel along the route of the cooking appliance, when the microprocessor determines the route traverse time is less than a time for operating the cooking appliance during performance of the recipe.

4. The mobile food production management system of claim 1, wherein the cooking appliance is disposed on a truck.

5. The mobile food production management system of claim 1, wherein the map source is disposed on the truck.

6. The mobile food production management system of claim 1, wherein the map source is remote form the truck.

7. The mobile food production management system of claim 6, wherein the map source is in communication with at least a second cooking appliance.

8. The mobile food production management system of claim 1, wherein the library is disposed on the truck.

9. The mobile food production management system of claim 1, wherein the library is remote form the truck.

10. The mobile food production management system of claim 9, wherein the library is in communication with at least a second cooking appliance.

11. A method for managing the operation of a mobile cooking appliance comprising the steps of:
determining a current location of the mobile cooking appliance;
receiving, at the mobile cooking appliance, an order to prepare food with the mobile cooking appliance; the order including a delivery location for delivery of a food item prepared by the mobile cooking appliance;
obtain a recipe for a food item to be prepared with the mobile cooking appliance;
determine a route between the current position and delivery location to be travelled by the mobile cooking appliance; and
determining whether the time required to travel the route is greater than the time required for operating the cooking appliance during performance of the recipe.

12. The method for managing the operation of a mobile cooking appliance of claim 11, further comprising the step of: determining a delay time to begin travel along the route of the cooking appliance, when it is determined the route traverse time is not greater than a time for operating the cooking appliance during performance of the recipe.

13. The method for managing the operation of a mobile cooking appliance of claim 11, further comprising the step of: determining a delay time, after the begin of travel, to begin operation of the cooking appliance, when it is determined the route traverse time is greater than a time for operating the cooking appliance during performance of the recipe.

14. The method for managing the operation of a mobile cooking appliance of claim 11, obtaining the recipe from a library of recipes.

15. The method of managing the operation of a mobile cooking appliance of claim 14, wherein; the library of recipes is accessible by at least a second computer.

16. The method for managing the operation of a mobile cooking appliance of claim 11, wherein a position along the route is determined by at least one of an accelerometer or GPS.

17. The method for managing the operation of a mobile cooking appliance of claim 11, further comprising the step of accessing a map store to determine the route.

18. The method for managing the operation of a mobile cooking appliance of claim 17, wherein the map store is accessible by at least a second cooking appliance.
